(19) United States
(12) Patent Application Publication
(10) Pub. No.: US 2014/0207881 A1
(43) Pub. Date: Jul. 24, 2014

(54) CIRCUIT ARRANGEMENT FOR CONNECTION INTERFACE

(71) Applicants: Mondrian Nussle, Mannheim (DE); Benjamin Geib, Amsterdam (NL); Heiner Litz, Menlo Park, CA (US)

(72) Inventors: Mondrian Nussle, Mannheim (DE); Benjamin Geib, Amsterdam (NL); Heiner Litz, Menlo Park, CA (US)

(73) Assignee: RUPRECHT-KARLS-UNIVERSITAT HEIDELBERG, Heidelberg (DE)

(21) Appl. No.: 13/981,361

(22) PCT Filed: Jan. 26, 2012
(86) PCT No.: PCT/DE12/00060

§ 371 Date: Nov. 6, 2013

(30) Foreign Application Priority Data
Jan. 26, 2011 (DE) 10 2011 009 518.7

(51) Int. Cl. H04L 12/58

(52) U.S. Cl. CPC H04L 51/36
USPC 709/206

(57) ABSTRACT

The invention relates to a connecting interface having a circuit arrangement, in order to associate incoming data messages with available information, having a means for comparing incoming messages with available information and for storing available information. In this case, the means comprises a multiplicity of comparison elements that have a respective associated memory, wherein the respective memories together form a store for storing information relating to unassociated messages, and the comparison elements are designed for the parallel comparison of incoming messages with the information stored in their respective memories.

The present invention relates to the subject matter claimed as preamble and therefore relates particularly to the connection of computers in a cluster.

Today, complex computation tasks are executed to some extent on what are known as “computer clusters”, that is to say computers that interchange data with one another and that undertake calculations jointly.

The speed at which computation results can be generated in this case is dependent not only on the number of computer units available in the cluster, such as PCs, server blades and the like, and also the speed thereof, but also on how efficiently the individual units are able to interchange data with one another, because frequently partial results from one unit are required for further processing in another unit. In this case, data need to be transmitted quickly and efficiently. Fast transmission first of all requires data to be available as soon as possible after the data are sent or requested, which requires firstly short delay times (latency) and secondly good utilization of the available bandwidth. Good utilization of the available bandwidth usually means that the data that are actually intended to be transmitted can have only a small amount of pilot data, control data, etc. added as an “overhead”.

Besides the data that are actually required, such as the operands, partial results, etc., to be transmitted, the communication in clusters requires further information. By way of example, the data typically have information added that indicates the destination address, a particular process on the destination computer, typically characterized by what is known as the process identification (process ID), and also information about the length of a message, more preferably an explicit identification for the message, details about the type of the message, etc. This relevant supplementary information is added to the actual “payload” data during sending, is transmitted with said data in a data packet and is used in the receiver to identify the respective data packet and to correctly associate it with the respective process running on the destination computer unit, inter alia. In order to associate a data packet with a particular process on a destination computer unit, a matching method is typically carried out, which method involves alignment for whether a particular message has been awaited for an application, that is to say whether there is already an appropriate reception operation on the destination computer, or whether a message has not yet been expected or required. In this context, one problem, inter alia, is that this alignment needs to take place quickly and reliably, but the alignment cannot take account of more recent requests when messages are received approximately at the time at which the software also registers relevant demand for the incoming data. The relevant lists may moreover be very long and have several thousand entries, which makes the comparison process extensive and complex. The alignment can therefore require a considerable proportion of the system power.

US 2005/0078605 A1 discloses a method for ensuring the correct order of orderly data packets that arrive in disorderly fashion. To this end, a separate list is managed for each data source (that is to say each data transmitter).

Reference is also made to US 2010/0232448 A1.

Keith D. Underwood, Arun Rodrigues and K. S. Hemmert, “Accelerating List Management for MPI” and the paper by the same authors, “An Architecture to Perform NIC Based MPI Matching”, ISSN 1-4244-1388-5/07, 2007, disclose methods and apparatuses for performing matching with lower latency. A dedicated piece of hardware is proposed that is intended to perform the comparison more quickly. Reference is also made to Keith D. Underwood et al., “A Hardware Acceleration Unit for MPI Queue Processing”, Proceedings of the 19th EEE International Parallel and Distributed Processing Symposium (IPDPS'05).

It is frequently necessary to buffer and possibly recopy messages up to identification thereof, which is not only time consuming but also encumbers the system and requires power. Even if just the headers, that is to say the information to be added to the actual data, are transmitted and aligned and the actual data transfer is not performed until afterwards, there is still a considerable resultant encumbrance for a central processor unit (CPU) in a computer unit.

The fast processing thus also requires the destination unit, that is to say the location to which the data are sent, to be able to be used to quickly determine what is intended to happen with the received data. This is above all critical because firstly a multiplicity of threads and the like can be executed on the individual units in computer clusters too and secondly, moreover, data may need to be received from a plurality of sending units for a given computation task.

It is furthermore desirable to be able to effect the data transmission with only low expenditure of energy; particularly in computer clusters, this is critical because in this case a large number of computer units are arranged close together and the heat produced by said computer units needs to be dissipated—possibly by investing in expensive air conditioning systems and the like.

It is desirable for the data transmission in computer clusters to be embodied such that at least some of the aforementioned problems are at least partially alleviated in comparison with the previously known prior art.

The solution to this problem is claimed in independent form. Preferred embodiments can be found in the subclaims.

A first fundamental concept of the invention is therefore that incoming data messages are associated with available information using a multiplicity of comparison elements that have a respective associated memory, wherein the memories are organized such that they form a joint store for unassociated messages. This allows highly parallel access that, as such, is very fast and otherwise does not, in normal operation, bring about any encumbrance of a computer that is provided with the connecting interface according to the invention. Since the messages stored are not complete data streams but rather just headers, etc., relating thereto, that is to say identifiers that can be used to identify the data streams, the volume of information that needs to be stored for incoming, unassociatable data messages is very small, which also lowers the power consumption. The connecting interface will typically be part of a computer that is provided in a computer cluster, for example. However, it may be external to the processor or other parts of the PC, for example, that is to say may be optimized as a piece of dedicated hardware. A data message is understood to be incoming within the context of the present text when it arrives in the connecting interface, that is to say is either fed from the associated computer to the connecting interface, that is to say relates to a reception operation, or is received on said connecting interface from the outside. These may therefore be externally arriving requests for the acceptance of data streams to be sent to the connecting interface, which in this respect are unexpected, or requests from the associated computer for data to extraneous computers in the cluster or the like. It should be explicitly pointed out that the common store for unassociated messages does not involve any separation according to external transmitters, that is to say that a list is not created for each external transmitter. Whereas the text above states that such data transmissions take place in computer clusters, it should be pointed out that such connecting interfaces are also useful at other locations.

This allows highly parallel searching for old entries, which makes it possible to bring about matching very quickly. The use of parallel memories also achieves a desirably very large memory bandwidth in this case.

It is possible for the connecting interface to be designed to process, as incoming data messages, headers or the like from unexpected operations that are unexpectedly transmitted to the connecting interface externally or from outgoing requests (reception operations) from a computation unit that is connected to the connecting interface. It is thus in no way necessary to store the complete messages or to accept them as early as on request. This has several advantages straight away. Firstly, the data traffic on the network is reduced, which helps to make better use of the available transmission bandwidth and saves power. Secondly, less power and transmission bandwidth is also required inside computers if it is necessary to store and handle not complete, large data packets but rather initially just small identifiers, information, headers or the like relating thereto until the assignment has taken place and only then does the transmission to a therefore clearly defined (computer-internal) destination take place.

Preferably, the memory will be a dual port memory and/or a self-compacting memory and/or it will have an associated circuit that is designed to jointly store the age of an entry stored in said memory and to alter the age when the memory is accessed. The use of a dual port memory makes it possible to simultaneously read data for the comparison from the memory and write data in altered form back to the memory, for example when the age of an entry is increased or a match has been found and other data are intended to be written to the memory location of the match for the purpose of compactification. The use of a self-compacting memory is advantageous because although entries are typically stored in the order of their arrival in the memory, they are taken from arbitrary locations; in order to avoid “gaps” in the memory, compacting is therefore useful; the use of a memory that uses suitable circuits that are directly associated with it to fill these gradually arising gaps by “pushing together” the remaining memory content, that is to say is self-compacting, is advantageous insofar as it is not necessary to expend any computation time of the host computer or the like in order to prevent the data segmentation of the memory. In the case of dual port memories, it is possible to read data from the memory from one of the two ports in order to perform the comparison, and at the same time to write back read data via the second port, as required for compacting a possibly segmented content. Therefore, the compacting of the self-compacting memory when designed as a dual port memory does not prompt an increased time requirement; the use of dual port memories for self-compacting memories is therefore particularly preferred.

It is preferred if the store or, as is considered to be the same in this respect, the circuits or other means storing data in the memories is/are designed to jointly store data headers, identifiers, portions thereof or the like and preferably an, in particular progressively allocated, sequence number as information relating to unassociated messages. When a plurality of matches are found, this facilitates the selection of the information to be used for the further use.

It is preferred if a distribution means is provided in order to distribute information relating to received, unassociatable data messages to one of the respective memories from the multiplicity of comparison elements, particularly taking account of a round robin strategy and/or a current fill level of respective memories. This prevents a very large number of entries in an almost full memory from having to be processed in a comparison element while other instances of the comparison elements of the comparison pass ended very quickly on account of only a few entries. In this case, it is preferred to depart from a pure round robin strategy, that is to say from a strategy in which entries are uniformly distributed to the memory elements “in turn”, merely because over time a situation can arise in which matches found have been repeatedly removed from the list of a memory, with the result that these memories are emptied, whereas this is not the case with other memories.

Such a storage strategy is particularly advantageous in particular in comparison with methods in which all messages from the same source are stored in the same list, that is to say the same memory area. Experience shows that even in the case of transmitters that send a particularly large quantity of data packets there is no occurrence of resultant increased latency; this is advantageous because otherwise the data processing is impaired distinctly in the case of the particularly active transmitters.

It is possible and preferred for a first multiplicity of comparison elements to be provided in order to compare data messages received from outside, that is to say outside the computer in which the interface is provided, for example, with internal data requests (reception operations) for which no matching incoming message has previously been found, and for a second multiplicity of comparison elements to be provided in order to compare requests (that is to say reception operations) that are to be transmitted to the outside, that is to say from the computer in which the connecting interface is provided, for example, with unexpected operations that have previously been obtained from the outside, and also for a means to be provided in order to associate incoming data messages with the relevant first or second multiplicity of comparison elements for storage or comparison in order to prompt a comparison only on this multiplicity. In other words, the hardware of the comparison interface may be designed and operated such that requests to be sent via the interface only ever have to be compared with messages that have already been received thereon, but not with earlier requests to be transmitted, or incoming messages are compared only with earlier requests. This reduces the comparison complexity to a further substantial extent and decreases the times before a match is found and the expenditure of energy therefor.

Preferably, a distribution unit is provided in order to supply an incoming data message simultaneously to a plurality of comparison elements for parallel comparison with the information stored in the respective memory unit, for example for the purpose of a broadcast, wherein this distribution unit is particularly preferably designed to supply freshly incoming data messages to the plurality of comparison elements only when all the information to be stored has been stored and a decision about previously performed comparisons has been made. This prevents errors from occurring during output because a currently handled data message for which a suitable existing entry is not available and hence also cannot be found still has no corresponding entry in the memory for subsequent searches for precisely this currently handled information. Withholding a further request is the simplest method of avoiding resultant difficulties, which are referred to as a “race condition”.

It is also preferred if a unit is provided in order to select the oldest information from information that is available in a plurality of the plurality of comparison elements and that can be associated with incoming data messages as the information to be output so that a transfer of the relevant data packets can be prompted. This ensures that later, comparable entries are not used first and thus errors do not occur as a result of incorrect data orders.

A further preferred proposal is a connecting interface for a computer that interchanges data within a cluster, in which provision is made for the interface to have a plurality of ports and to be designed for data interchange with a respective other computer via each of this plurality.

It has therefore been recognized that an interface can advantageously be provided directly in the computation unit and can be used by the computation unit to communicate with a plurality of other units. This first of all renders hubs, switches, routers and the like superfluous and therefore saves both power and time (latency) during the data transmission. This can be regarded as patent-worthy on its own or in combination with other advantageous features and embodiments.

In this regard, it is preferred for enough ports to be provided on a computation unit to allow particularly favorable connection topologies such as a 3D torus or 6D hypercube topology to be implemented. Other topologies known to be advantageous for clusters may likewise be disclosed as being able to be supported.

It is also particularly preferred if the arrangement has an associated error detection stage for detecting data transmission errors that detects errors in the data packet prior to the internal data packet forwarding in order to prompt the retransmission of previously erroneously transmitted data packets upon detection of errors. In this case, internal forwarding can first of all be understood to mean forwarding to those units to which the central processor unit(s) of the destination computer unit has/have direct access for data processing; however, it is particularly preferred if the retransmission is already prompted before stages—particularly inside the connecting interface—concerned with the association of incoming data with processes running on the destination computer unit. This has the advantage that the subsequent processing stages in the computation unit are not encumbered by the handling of erroneous data packets. The data packets may be requests for data transfers or even form complete data transfers.

It is particularly preferred if a data transmission error detection stage is not provided for a plurality of connecting interface ports but rather, as is possible, error detection is performed directly at each input, to which end an appropriate multiplicity of independent error detection stages can be provided; these can also execute error detection algorithms implemented permanently in hardware.

It is also preferred if short and long data packets can be interchanged in different ways, particularly using different hardware units, to which end the interface may accordingly be physically provided with different hardware units for short and long data packets. These hardware units can preferably be selectively supplied either with an incoming data packet or with an incoming message; to this end, in one preferred variant, the type of message can be identified directly at the input port. Corresponding message type identification means, particularly message length identification means, are provided. This has the advantage that short data packets can be transmitted immediately, possibly with buffer-storage in buffer stores and the like, which necessitates only a low memory requirement in the case of short data packets, whereas longer data packets can be interchanged such that first of all a header or the like is transmitted and only then, when the data packet that has thus been announced is associated and an appropriate destination or destination process in the destination computer or the destination computation unit is determined therefor, does the actual data transmission take place.

It is possible and preferred for memory space to be reserved in the memory of the computation unit, particularly in the main memory (RAM) of the computation unit or of the computer, for storing short messages, and specifically it is particularly preferred for a separate memory area to be provided for each running thread.

It is possible and preferred, for the purpose of transmitting longer data packets, for a unit to be provided that is used to stipulate which remotely situated memory area is intended to be accessed, particularly on a read and/or write basis, and wherein preferably the unit is also designed to be able to recognize and/or signal successful or unsuccessful read and/or write operations. This is advantageous because longer data packets, that is to say data packets that comprise a large quantity of information besides the header, can thus be written directly to the location at which they are found and required by the software on the destination computer unit or can be retrieved from a memory location at which they are currently located, with the result that transmission with just a little buffer-storage is possible in particularly unproblematic fashion. Since successful read and/or write operations are attained, there is also a substantial reduction in the need for intervention by a central processor unit, which in turn decreases the computer load, and appropriate memory areas can possibly also be enabled, for example after a successful read operation.

It is accordingly particularly preferred and possible to also embody the hardware of the interface such that shorter and longer data packets can be sent to respective different locations and a programmable hardware location is provided in order to determine the placement or the destination of the short data packet in the manner of a programmable I/O; for longer data packets, in contrast, access in the style of (remote) direct memory access preferably takes place in practice.

It is possible and advantageous for an address translation unit for translating global or virtual addresses into local or physical addresses to be provided in order to facilitate access to remotely located memory areas during the data packet transmission, particularly by allowing access that is free of software intervention. An address translation unit makes it possible to provide facilitated access to remotely located memory areas without excessive encumbrance arising for the central processor unit of a computer unit.

The connecting interface of the present invention will, as can be seen from the above, typically contain a multiplicity of separate, different hardware units, some of which implement different functionalities. It is preferred if various units can be connected to one another in the connecting interface by virtue of the provision of a root capability, particularly a crossbar switch.

It is also preferred if status or register file means are provided in the connecting interface in order to be able to read and/or alter settings and/or states of the connecting interface or of components. Typically, this can be accomplished by the computer unit with which the connecting interface is associated. However, the possibility of remote access to status and/or register files on a read or write basis should be pointed out.

It is preferred if a comparison between pending transactions, that is to say particularly requested data transfers, on the one hand, and incoming data packets, on the other, can be performed in the connecting interface itself. In this case, the transfer request made can firstly be performed by an extraneous, sending unit that requests whether, when and/or to where an, in particular longer, data packet can be sent or from where it can be retrieved; alternatively, a data transfer request can be made such that the computer unit itself asks one or more other connected computer units and the like for required data. It should be pointed out that data for transmission to third units can possibly also be provided in the memory means.

These mechanisms achieve extensive autonomy for the connecting interface, which means that the central processor unit of the computation unit can be relieved of load; it is self-evident that individual instances of the mechanisms described above are already regarded as advantageous on their own and hence are regarded as separately worthy of protection.

It is advantageous if the connecting interface at least contains a protocol control or translation unit that, in particular, can combine a plurality of data packets such that a joint larger data area can be formed given limited data packet sizes, and/or that controls the data flaw or stream in this manner, particularly between the crossbar and at least one of the units (that are typically connected to the crossbar) such as the address translation unit, the status and/or register file means, the short data transmission unit and the data packet mark comparison unit. This further improves the performance of the interface according to the invention.

The invention is described below merely by way of example with reference to the drawing, in which

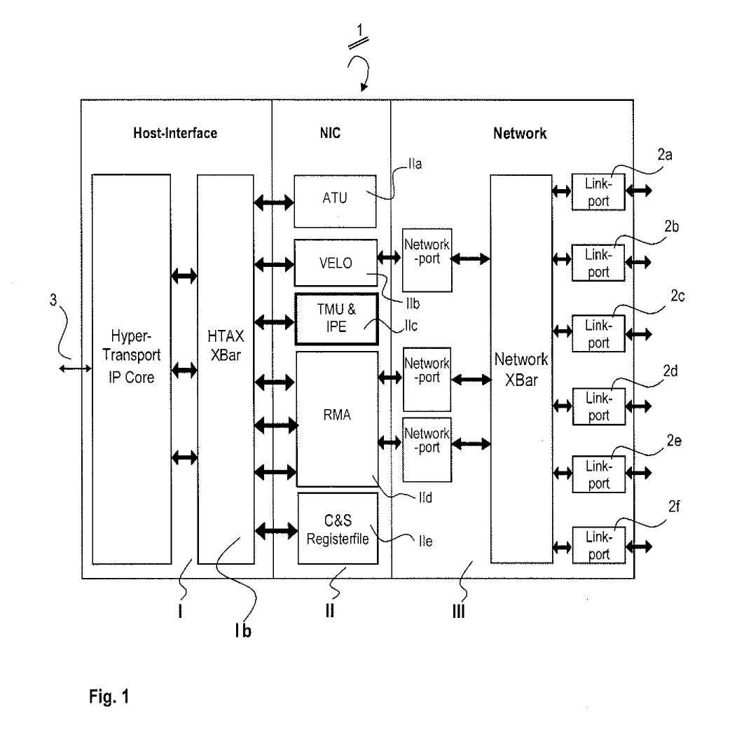

FIG. 1 shows a connecting interface of the present invention,

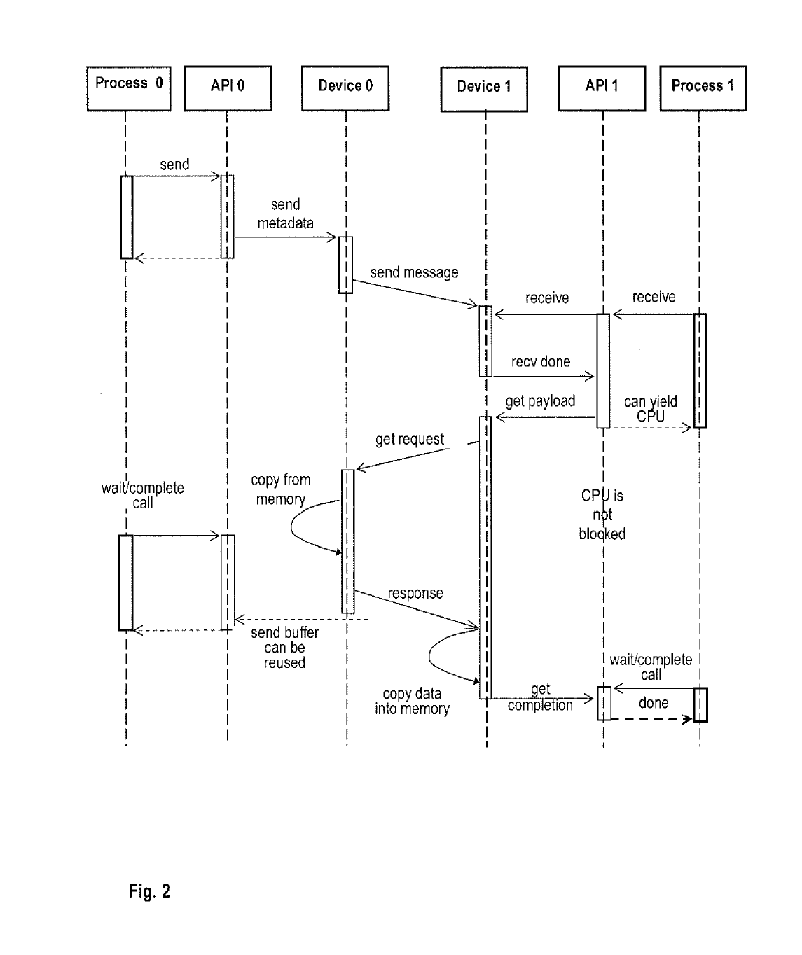

FIG. 2 shows the communication sequence on the connecting interface, and

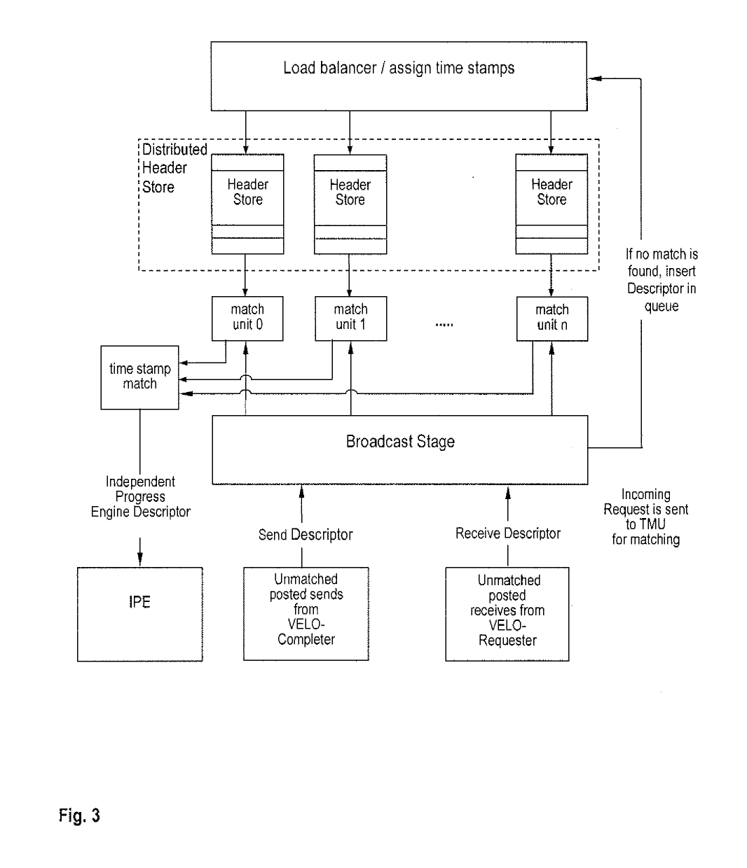

FIG. 3 shows a detail from FIG. 1.

According to FIG. 1, a connecting interface 1 that is denoted generally by 1 comprises, for computer that interchanges information with units of a cluster of computation units (not shown) via ports 2a, 2b, 2c, 2d, 2e, 2f that are referred to as link ports, which computer communicates with the connecting interface 1 via an interface 3 in the present case, a plurality of ports 2a-2f that are each designed for interchanging data with a plurality of other computation units.

In this case, FIG. 1 shows that the connecting interface is essentially divided into three functional blocks I, II and III between which respective information is interchanged, as indicated by the arrows that run across between the blocks.

The first block I relates to the host interface, which is used to link the connecting interface to the processor of the computer unit. In one practical implementation, this may be a bus that is coupled particularly closely to a CPU, such as on the basis of the hypertransport protocol for direct linkage to OPTERON processors from the AMD company. Whereas such direct linkage is admittedly not absolutely necessary, it has the advantage of significantly reduced latency. In the present case, the interface to the—as indicated preferably—processor-adjacent bus Ia is connected by means of a crossbar Ib to various units of the second function block, which is a network interface controller.

The second block II is the network interface controller. The network interface controller II comprises a plurality of modules that in this case, as possible and preferred, are implemented by separate hardware units or stages. These are an address translation unit IIa, a short message unit IIb, a piece of protocol-accelerator-implementing hardware IIc, a remote memory access unit IId and a status and register file unit IIe.

The address translation unit (ATU) IIa is designed such that it can be used to associate a global virtual address with a local physical address in order to be able to read from or be able to write to the main memory of the local computer unit, that is to say of the local node. In this case, the address translation unit is preferably designed such that address conversion can take place without an operating system call; the measures required for this are known to an average person skilled in the art.

The short message unit IIb is designed to be able to send and receive short messages quickly. In this case, the messages are meant to have only a short length, based on the “payload”, that is to say based on those data that can be transmitted besides the additional information in the data header. In the present case, the short message unit IIb is therefore designed to transmit only messages with a size of between 8 and, by way of example, 256 bytes; in principle, the possibility of dividing or splitting longer messages into a plurality of small messages should be pointed out. The short message unit IIb typically works both by using programmed I/O and by using the DMA technique. In this case, the short message unit IIb is designed such that messages can be sent by PIO and received by DMA. Hence, the software can send the data directly to hardware without first storing it in the main memory and informing the hardware about the placement in the memory, as is the case with the DMA technique.

The short message unit is thus used to produce requests that are forwarded to protocol units locally or remotely. The RMA unit uses RDMA GET requests and produces termination messages in accordance with the modification scheme of the RMA.

In addition, for each running software thread, the short message unit IIb has access to a reserved area in the main memory in order to store incoming messages therein. The fact that this requires the provision of appropriate access management means such as pointers, etc., is considered to be obvious and is therefore not discussed in more detail. The software, which is executed on the central processor unit, can then use polling, for example, to check the areas for whether new messages have been received.

The unit IId for remote memory access (RMA) is designed to transmit larger volumes of data. To this end, means are provided for using DMA access to directly access a remotely located memory, that is to say a memory in the destination computation unit of the cluster, which can largely relieve the load on the local computation unit, since the RMA unit merely needs to receive information about the remotely located area to which read and/or write access is intended to be effected and where the data are correspondingly intended to be read and/or written locally. The remote memory access unit IId is designed to send a communication, when an operation ends, that can be used to signal to a program whether or not a remote access operation was successful. This can be accomplished by setting interrogatable flags for polling, by interrupt generation, etc.

The address conversions for reading and/or writing are performed by the address translation unit IIa preferably directly on the remote node, which allows an operation that is free of software support.

The control status and register file unit IIe is designed to make it possible to read and set status information for the connecting interface or the stages, blocks and units thereof.

The hardware IIc implementing protocol accelerators is used to associate the incoming messages with the requested data or running threads, as will be described in more detail below.

Block III is the actual network portion.

The units of block II, that is to say of the network interface, communicate with this network portion III, specifically in the present case via a plurality of network ports IIIa, IIIb, IIIc, the present exemplary embodiment having provision for just one network port IIIa for connecting the short message unit lib to the network portion III, whereas two network ports IIIb, IIIc are provided for the communication of the memory access unit IId. This is useful insofar as transmission of longer messages means that the port may be blocked for longer and therefore is not available for further tasks. Understandably, however, the RMA unit IId should—as is the case here—be designed to be able to handle more than one request at a given time. The network ports IIIa, IIIb, IIIc are used for converting the packets from the network interface to that data structure that is used in the (cluster) network. In other words, a protocol converter functionality is implemented by a protocol converter means.

In one preferred embodiment, the data transmission between computer units in the cluster takes place on a credit basis, that is to stay in the style of flow control. It should be pointed out that the network ports are designed to combine and buffer-store data packets received from the network until the packets are retrieved from the network by a functional unit. The network ports therefore have an internal memory means. This is particularly a memory means for data packet amalgamation.

The network ports IIIc to IIIc can each be selectively connected to one of the link ports III2a, III2b, etc.

The network ports IIIa to IIIc are connected to the link ports using a further crossbar IIId. As is possible and preferred, the latter is in this case designed such that each input/output port combination can communicate at the same time. In addition, it is designed to use credit-based flow control, which avoids buffer memories overflowing. The crossbar is in this case equipped with a plurality of virtual channels that share one and the same physical medium. This allows data streams from various functional units to be logically separated and avoids deadlocks.

In the preferred embodiment shown, the crossbar contains logical queues for each combination of virtual channel and output port, which are used to separate the independent data streams from one another. In this case, each incoming data packet in the input port can be sorted into an appropriate queue, and these queues only need to store pointers pointing to the data, for which purpose the queues require comparatively little memory, while the data themselves are located in the data buffer that is common to all queues.

The link ports III2a to III2f are designed to effect error-free transmission of the packets to the remote computation units or nodes of the cluster, to which end the exemplary embodiment described has an appropriate error control mechanism implemented in it in order to effect further transmission upon detection of erroneous reception. Hence, error-free packet transmission is effected for the functional units with which the local computation unit or the local node communicates, without the whole system being massively encumbered by the error correction.

The use of the unit according to the invention now comes down to correctly and quickly associating the data arriving for a multiplicity of threads, specifically regardless of whether these data have been requested by a thread, that is to say that a corresponding reception operation exists, or whether they arrive unexpectedly.

It is important that the association needs to be made quickly without problems arising as a result of messages arriving in the meantime or in staggered fashion. To this end, an alignment or matching unit now contains a plurality of parallel units that are used to simultaneously compare incoming messages or requests with information regarding already received data. In the event of an unsuccessful search using these units, the incoming messages are stored such that a later search for them is possible. In the event of a successful search, the parallelism is first of all taken as a basis for ensuring that reference is made to the oldest of the existing stored messages. In addition, it is necessary to ensure that problems do not arise as a result of too many or too old existing messages. This is accomplished specifically by means of hardware and processes that use the latter, as follows:

The matching unit is provided with a number of elements operating in parallel that search the stores—which are each likewise provided in parallel—of older information for which no match has been found previously. In the event of a plurality of the elements operating in parallel finding a match, a selection means for selecting the correct match is provided, to which the elements operating in parallel report the matches that they have found, this selection means then being arranged to determine the age of the matching entries found in the different elements and the stores thereof and to select the oldest of these entries. In addition, the matching unit is provided with logic for transmitting incoming messages to the elements operating in parallel, with logic for storing incoming information for which no match has been found, and with logic for handling overflows, etc.

With this proviso, a unit makes a transmission request, which indicates who sends whom how much data from what address, and also a tag, which the software can use for message identification.

This transmission request is sent via the network to the receiver, is checked therein to ensure that it is free of error, and, assuming error-free transmission that does not necessitate retransmission, is then checked in the matching unit.

If the matching unit finds appropriate data, that is to say that there is a successful match, then the information found is forwarded, together with the transmission request, to the protocol sequencer, which performs one or more RDMA GET transactions in order to transmit the data from the transmitter to the receiving process. This operation results in notification both of the receiver and of the transmitter, which successfully ends the transmission/reception process. If, by contrast, no matching entry is found for the transmission request during the matching operation, said request is entered in the internal matching structures, specifically—in this case—just the metadata, that is to say the information indicated above about volume of data, destination address, software tag, etc.; it should be mentioned that it would be possible, per se, to store more information than just the metadata, however.

At the reception end, when a software process requires data, a RECEIVE request is made, which contains a record of how many data items are required, where said data items are intended to be received, which receiver requires them and which tag is intended to have an associated transmission request. It should be pointed out that the invention also allows particular details not to be determined completely, but rather “wildcards” to be provided, which allow a match with various and any receivers and/or tags.

As mentioned, a number of elements operating in parallel are provided that each have stores—likewise provided in parallel—of older information, to be more precise implement a header store, that is to say a queue, which can be used to store both unexpected transmission requests and sent reception requests; this header store is logically divided into two queues, namely a portion for the unexpected operations and a portion for the sent reception requests.

Thus, the invention has a series of header stores and matching elements implemented in parallel, which is able to clearly speed up the linear search through the header store. Since one store is used per matching unit, sufficient memory bandwidth for a fast and efficient search is implemented at the same time. Associated with the header store is the actual comparison element, which can compare the next header from the store with an incoming request at a given time within a clock cycle. The fact that the header store can work for various receiver processes simultaneously by virtue of its being partitioned should be disclosed as a possibility.

For the parallel search, an exact chronological order is guaranteed by an explicit sequence number—allocated by logic associated with the matching unit—for each entry so that the oldest request can be selected when a plurality of matches from various units are positive.

Within the respective elements themselves, a plurality of which exist in parallel, the correct order for the stored information is first of all ensured by an FIFO data structure. In this case, the age of an entry can be determined by associating the age “0” with an entry when it is added to the list and incrementing this age whenever the queue is searched. It should be mentioned here that during a search all header stores are blocked against the insertion of new headers.

In this case, as is possible and preferred, the FIFO data structures are self-compacting, which allows easy-to-pipeline, linear passage through the memory with relatively low management complexity. It is advantageous if the queues are organized so as to be self-compacting, the values in said queues always being added to the end of the queue beforehand in chronological order, but being able to be removed from any location within the queue. Without countermeasures, this would result in the queue segmenting, that is to say that gaps between the actual values recurrently occur at those locations at which values have been removed. This is prevented by compacting; this involves the gaps being filled again by shifting the values that still remain in the queue. This can take place automatically, that is to say without the intervention of the host computer, it is referred to as self-compacting. For the actual self-compacting, the exemplary embodiment uses—as preferred—a dual port memory, with the compacting process being able to be performed in parallel with an actual search. During the compacting, the age of each entry can also be incremented at the same time. This involves the use of one of the ports to read a value and the use of the other port to write back a value with an incremented age such that gaps are closed when necessary.

The selection means, which selects the correct match among the matches found by all elements for a received message, may therefore simply be in the form of a timestamp comparison unit, and in this case it is formed such that the sequence numbers are thus determined in the same way as the age and, given a plurality of positive entries from parallel elements, the correct one is chosen and forwarded.

This significantly improves the latency. In addition, no crossbar is required and the arrangement can readily be scaled.

It is now also useful to relieve the load on the various elements provided in parallel in equal measure. To this end, it is necessary to prevent the FIFO store of one element from being almost full while the FIFO stores of other elements are almost empty. To this end, as further logic, the matching unit contains a load equalization unit, which is designed to distribute sent reception units and sent transmission units to the various match units and the relevant header stores thereof by taking account of the utilization level or fill level thereof. In this case—as is preferred and possible—this load equalization logic is implemented with a mask register, by means of which those elements whose stores hold the reception headers, that is to say the information relating to reception operations transmitted by the host computer, can be distinguished from those that store the headers of unexpected, that is to say unexpectedly arriving, messages.

The headers are associated as appropriate. In order to store a header, the load equalization logic analyzes the MPI area of an incoming header and checks the fill signals of the various header stores. If a plurality of the header stores are not yet completely full, incoming headers are distributed on the basis of a round robin technique. At the same time, the load equalizer manages the sequence number counter for each MPI area. A header that is stored in a header queue receives a sequence number from this sequence number counter, and the sequence counter is then increased. The sequence number counter is reset after a match has been found.

In order to prevent race conditions, the load equalization unit is in a form such that it waits until a current match process is completely finished before a header store has a new header added, and conversely the next match process waits until all available headers have been added completely.

In order to be able to align a header in all parallel elements simultaneously, these headers that are to be aligned must also be transmitted to the parallel elements. To this end, a header broadcast means is provided. This is designed to first of all wait until all elements have ended their current alignment and until the aligned header, if not yet matched, has then been inserted into one of the header stores or, if a match has been found, until the matched header has been transmitted to the sequence; only then is the next header transmitted by the header broadcast means using a header broadcast. It should be mentioned as obvious that appropriate control logic that operates on the basis of state is provided for this purpose. It should also be pointed out that the header broadcast means may be a multistage module if the number of elements existing in parallel becomes too great. It is also possible, if necessary, always to search simultaneously on the stores for posted transmission data and posted reception data, provided that race conditions are avoided in this case, which can be accomplished by means of a prior check on whether these two would match or by only permitting different ranks to match simultaneously.

In the arrangement described hitherto, problems could arise if no matches are found for a very long time, because this results in overflows being able to occur, stores being full, etc.

As soon as the sequence counter overflows, the chronological order can no longer be ensured. Logic means are therefore provided which prompt a dummy match to be performed on the relevant queues as soon as a sequence counter overflows, which dummy match, although not providing an actual result, increments the age of all entries by one, which then allows the sequence counters to be set to zero without any problems.

If, by contrast, the headers of an area reach their maximum age, an exception interrupt is output to the host CPU and all entries are transmitted to the main memory. At the same time, the hardware matching is suspended until it is put back into operation by the software.

If the header queue overflows, further processing of incoming data packets headed for the overflowing queue is stopped and the host CPU is likewise informed by a relevant interrupt. Incoming data packets are then routed to the main memory instead until the header queue overflow has been handled by the software. As in the case of overageing of the headers, all headers are written to the main memory and a software header matching algorithm is performed. In each case, the hardware matching can then be put back into operation by the software. It should be pointed out that it is possible to prevent this situation by means of the software by means of suitable scheduling and a suitable control flow.

The above mechanisms for overageing are based on handling of the problem and hence also of the matching by the software. To provide assistance for this, operation in bypass mode is also made possible. If an exception has occurred, the hardware matching can therefore be suspended and replaced by the software matching, in which case all headers are sent to a main memory queue in order to perform the software matching. This is called bypass mode.

If necessary, the software can also decide that headers are put into the queues again and the hardware matching is put back into operation, with all headers first of all being written to the queues in chronological order while both the match unit and possibly incoming network traffic are still blocked until normal operation can be resumed. However, it should be noted that in the case of the hardware dump described the entries in the main memory are no longer in order, but rather the software needs to carry out reordering by taking into account the sequence number and the age.

In the event of new entries during bypass mode, the software also needs to ensure an order, since said new entries are no longer provided with valid sequence and age information.

In summary, incoming sent reception messages or sent transmission messages are thus transmitted to the tag match unit. The distribution stage determines the header type, that is to say determines whether a transmission or reception operation is involved, and forwards the header to the relevant comparison elements. The comparison of incoming headers against all headers that already exist in the specific header queues is performed in parallel, to which end the specific header queue of the specific MPI area is respectively searched. The chronologically first match for this header is communicated to the selection means, that is to say the timestamp match units, by indicating the timestamp for this header. When all (match) elements operating in parallel have ended their search, the selection means, that is to say the timestamp comparison unit, takes the matches and determines the one with the oldest timestamp, after which the relevant header is retrieved from the match unit and forwarded to the IPE. If no match has been found, the header is forwarded to the load equalization unit, on the other hand, which inserts the header into a header store queue, with no new headers being transmitted by the broadcast stage during the insertion.

The method described above allows communication that can still bring about improvements even in highly parallel systems, in which typically the addition of ever further processors or computer units can result in impairment of the execution times. The typically CPU-controlled interventions that are required with conventional protocols and hardware and that have to transfer incoming and/or outgoing or transmitted data can be avoided. In this case, initially not complete, long messages are transmitted but rather only information relating thereto, for example the headers. These are typically significantly shorter than the complete messages; accordingly, the queues can end up shorter because it is not necessary for the complete information to be stored; it is possible, for example using the alignment described above, to determine a memory location to which incoming (complete) messages need to be written and, possibly even automatically, to prompt data to be sent thereto; alternatively, that process that is intended to process the data on the host computer also merely needs to be sent the address of the data on the extraneous computer; thus, remote memory access is provided.

However, it should be mentioned that although it is advantageous for long messages, in particular, not to be stored completely in the queues as well, the comparison method of the present invention still affords advantages even if this should be the case. The comparison method of the present invention is therefore particularly independent of, by way of example, the protocol of the message transmission, of the linking of the interface to the host computer, of the number of input/outputs that exist in the interface, etc.

Therefore, no memory bandwidth disappears, but rather a zero copy protocol is implemented.

In addition, the invention affords the advantage of scalability, that is to say that adjustment to suit increasing data interchange rates is possible without additional complexity by simply providing more stores in parallel with one another. This shortens the length of the lists with which a comparison needs to be performed, and therefore massively decreases the latency. The times required for the in addition to the comparisons of the list contents are usually not particularly significant in this case.

1. A connecting interface having a circuit arrangement, in order to associate incoming data messages with available information, having a means for comparing incoming messages with available information and for staring available information, characterized in that the means comprises a multiplicity of comparison elements that have a respective associated memory, wherein the respective memories together form a store for storing information relating to unassociated messages, and the comparison elements are designed for the parallel comparison of incoming messages with the information stored in their respective memories.

2. The connecting interface as claimed in claim 1, which is designed to process, as incoming data messages, headers or the like from unexpected operations that are transmitted to the connecting interface or from outgoing requests from a computation unit that is connected to the connecting interface.

3. The connecting interface as claimed in claim 1, characterized in that the memory is a dual port memory and/or a self-compacting memory and/or it has an associated circuit that is designed to jointly store the age of an entry stored in said memory and to alter the age when the memory is accessed.

4. The connecting interface as claimed in claim 1, characterized in that the store is designed to jointly store data headers, identifiers, portions thereof and the like and preferably an, in particular progressively allocated, sequence number as information relating to unassociated messages.

5. The connecting interface as claimed in claim 1, characterized in that a distribution means is provided in order to distribute information relating to received, unassociatable data messages to one of the respective memories from the multiplicity of comparison elements, particularly taking account of a round robin strategy and/or a current fill level of respective memories.

6. The connecting interface as claimed in claim 1, characterized in that a first multiplicity of comparison elements is provided in order to compare data messages received unexpectedly from outside with internal data requests for which no matching incoming message has previously been found, and a second multiplicity of comparison elements is provided in order to compare requests that are to be transmitted to the outside with unexpected operations that have previously been obtained from the outside, and also a means is provided in order to associate incoming data messages with the relevant first or second multiplicity of comparison elements for storage or comparison in order to prompt a comparison only on this multiplicity.

7. The connecting interface as claimed in claim 1, characterized in that a distribution unit is provided in order to supply an incoming data message simultaneously to a plurality of comparison elements for parallel comparison with the information stored in the respective memory unit, wherein this distribution unit is particularly preferably designed to supply freshly incoming data messages to the plurality of comparison elements only when all the information to be stored has been stored and a decision about previously performed comparisons has been made.

8. The connecting interface as claimed in claim 1, characterized in that a unit is provided in order to select the oldest information from information that is available in a plurality of the plurality of comparison elements and that can be associated with incoming data messages as the information to be output so that a transfer of the relevant data package transmission can be prompted.

9. The connecting interface as claimed in claim 1 for a computer unit that interchanges data within a cluster, wherein the interface preferably has a plurality of ports and is designed for data interchange via each of this plurality with a respective different computer, and preferably at least four, particularly preferably six, ports thereon are provided in order to allow connection of respective two-dimensionally or three-dimensionally arranged closest neighbors and/or to implement a 3D torus topology and/or a 6D hypercube topology, wherein preferably a data transmission error detection stage that can be operated independently of other connecting interface components is provided on each port in order to detect a data transmission error prior to internal data packet forwarding and to prompt retransmission of previously erroneously transmitted data packets in response to detected errors, and/or the interface is designed to interchange short and long data packets in different ways, particularly using different hardware units, and/or the interface is designed to send shorter data packets to a programmable hardware location, preferably by providing a unit that transmits short messages, with preferably reserved memory space in the computer main memory being provided for short message storage for each of a plurality of running threads, particularly at least one memory area for each running thread.

10. The connecting interface as claimed in claim 1, characterized in that, preferably for the purpose of transmitting longer data packets, a unit is provided that stores which remotely located memory area is intended to be accessed, particularly on a read and/or write basis, wherein the unit is preferably designed to output advice of the successful read and/or write operations and/or advice of an unsuccessful read and/or write operation and/or in that an address translation unit is provided for translating between local and physical addresses and global and virtual addresses in order to facilitate access to remotely located memory areas during the data packet transmission, particularly by allowing software-intervention-free access, and/or in that a crossbar switch for connecting various units is provided in the connecting interface and/or in that a status and/or register file means is provided in order to read and/or alter the state of the connecting interface and/or settings thereof and/or in that a protocol control and/or translation unit is provided, particularly for the purpose of data packet merging and/or for the purpose of flow control, particularly between the crossbar and at least one of the units from address translation unit, status and register file means, short data transmission and data packet mark comparison unit.

11. A method for operating a cluster of computer units, wherein each of a plurality of computer units in the cluster communicates with other computer units in the plurality by means of a direct connecting interface, particularly a connecting interface as claimed in one of the preceding claims, and in this case preferably the interchange of short or long data packets is handled differently, particularly by transmitting longer data packets only after transmission of a destination memory area for the data packet access in the destination computer unit.

12. A method for associating incoming data messages with available information, wherein incoming messages are compared with available information and available information is stored, characterized in that a comparison is performed in parallel with a multiplicity of comparison elements that have a respective associated memory, wherein the respective memories jointly form a store for storing information relating to unassociated messages and the comparison elements compare incoming messages in each case with the information stored in their respective memories.
